(19) United States
(12) Patent Application Publication
(10) Pub. No.: US 2007/0078253 A1
(43) Pub. Date: Apr. 5, 2007

(54) Super soft elastomers as skinning material for composites

(76) Inventors: Dagmar Ulbrich, Koln (DE); Ralf Guether, McDonald, PA (US); Franz-Josef Bohne, Leichlingen (DE); Marc Schutze, Dortmund (DE); James W. Rosthauser, Pittsburgh, PA (US); John H. Perry, Scenery Hill, PA (US)

Correspondence Address: BAYER MATERIAL SCIENCE LLC, 100 BAYER ROAD, PITTSBURGH, PA, 15205, US

(21) Appl. No.: 11/241,208

(22) Filed: Sep. 30, 2005

(51) Int. Cl. C08G 18/00

(52) U.S. Cl. 528/44; 264/255

(57) ABSTRACT

The present invention relates to soft sprayable polyurethane elastomers which exhibit low hardness without the addition of plasticizers. Other aspects of this invention are composites with a soft touch surface and processes of making these composites. These composites may also be decorative and/or pigmented composites.

### BACKGROUND OF THE INVENTION

The present invention relates to sprayable elastomers and a process for preparing these sprayable elastomers. These elastomers are the reaction product of a polyisocyanate with an isocyanate-reactive component. This invention also relates to an improved process for the production of composites, and the resultant composites.

Rigid composites are often used for structural or decorative applications in automotive interior parts, construction parts and leisure articles. Soft composite materials are generally used in seating applications, exercise equipment pads, support pads in spas and jacuzzis, automotive interior parts, medical aids, etc. Typically, composite materials such as these are prepared from a foam which is subsequently covered with a flexible material such as, for example, vinyl or fabric.

Processes for producing composites covered with soft materials are known. Problems associated with these known processes and the corresponding products include additional process steps/labor requirements, additional equipment, increased cycle time, and generation of waste material.

Recent developments in the automobile industry include developing non-fabric automotive trim components. Known systems for producing decorative components include polyvinyl chloride (PVC) vacuum and rotocast systems, thermoplastic polyolefin (TPO) vacuum formed systems, and thermoplastic polyurethane (TPU) rotocast and spray aliphatic urethane systems. Each of these has problems associated with the material and/or the process.

Aside from the environmental issues associated with, for example, PVC, skins based on PVC are stiff and have a poor feel. Stiffness and a poor feel are also common problems for TPO vacuum formed skins. To improve skin stiffness and feeling, plasticizers such as phthalates (e.g. dioctylphthalate (DOP), dibutylphthalate (DBP)) or adipates are often added. In general, plasticizers tend to migrate out of the material causing a deterioration of the skin properties and possibly health problems. The TPO systems are also known to result in poor quality grain definition. Finally, TPO systems require an additional coating to be scratch-resistant.

U.S. Pat. No. 5,116,557 describes integral skin applications and a method for making mold components having a low density. In this disclosed method, a layer of light stable polyurethane elastomer of a pre-determined color is sprayed onto a mold surface and then a synthetic foam composition is injected into the space of the mold cavity while the elastomer is still tacky. After curing, the molded object is removed. This process, while overcoming some short-comings of earlier known processes, will increase cost and possibly require additional steps to ensure adhesion with a urethane foam. Other known problems include issues related to matching of color, poor fog resistance and a poor feel of the produced skins.

Soft molded composites based on polyurethane and polyurethane ureas and processes for making these are described in U.S. Pat. No. 6,294,248. These processes require the elastomer-forming composition to have a gel time of from about 15 to about 120 seconds. This is to ensure that the elastomer coating on the walls of the mold is sufficiently set so that the filling material mixture will be substantially contained within the elastomeric coating. Composite articles are produced in a simple one-step process with relatively short cycle times. This molding process generates little waste and requires less labor and equipment than current commercial processes.

U.S. Pat. No. 6,432,543 discloses a specific sprayable elastomer composition for making components which are particularly suitable for the automotive industry. These components have a molded elastomeric outer layer and an inner polyurethane foam layer. The elastomer is the reaction product of an aromatic polyisocyanate, a solids containing polyol, a second polyol, and other additives. The total solids content of all components except the polyisocyanate is up to 40 wt. %. Hardness of elastomers containing this amount of solids is generally limited to the range of 70 to 85 Shore A.

### SUMMARY OF THE INVENTION

Advantages of the present invention include the fact that the elastomeric skins are soft and have a good feel. Hardness of the elastomers can be in the range of 20 to 70 Shore A.

These and other advantages which will be apparent to those skilled in the art are accomplished by reacting a polyisocyanate with an isocyanate-reactive component that includes at least 70% by weight of a specified type of isocyanate-reactive compound and up to 30% by weight of an amine having primary or secondary amino groups satisfying specified molecular weight, functionality and NH number requirements.

### DETAILED DESCRIPTION OF THE INVENTION

This invention relates to sprayable elastomers and to a process for preparing spray elastomers.

The sprayable elastomers of the present invention are soft polyurethane-urea elastomers which exhibit low hardness without the addition of plasticizers. These sprayable elastomers are the reaction product of:
(A) a polyisocyanate and/or NCO-prepolymer and/or modified polyisocyanate;
with
(B) an isocyanate-reactive component comprising:
   (1) from about 70 to about 99% by weight, based on 100% of the combined weight of components (1) and (2), of one or more compounds containing from about 1.5 to about 6 isocyanate-reactive groups other than primary or secondary amine groups having a number average molecular weight of from about 60 to about 8000, and an OH number of from about 14 to about 1870,
   and
   (2) from about 1 to about 30% by weight, based on 100% of the combined weight of components (1) and (2), of one or more compounds containing from about 1.5 to about 4 primary or secondary amine groups, having a number average molecular weight of from about 60 to about 500, and an NH number of from about 225 to about 1870; and optionally
(C) one or more catalysts,
(D) one or more anti-oxidants,
(E) one or more UV stabilizers,
and
(F) one or more colorants,
   in which the ratio of the total number of isocyanate groups present to the total number of isocyanate-reactive groups present is from about 0.80:1 to about 1.20:1, preferably from about 0.90:1 to about 1.10:1, and most preferably, from about 0.95:1 to about 1.05:1. These elastomers do not require an internal mold release agent.

The present invention also relates to composites comprising these elastomers and to an improved process for the production of these composites.

The composites of the present invention are produced by (1) applying, preferably by spraying, a composition which forms a soft polyurethane-urea elastomeric layer after application to all of the interior walls of an open mold, (2) closing the mold, (3) introducing a polyurethane-forming composition which will form a polyurethane filling material into the mold in a manner such that the filling material composition will be substantially completely within the elastomer-forming composition, and (4) allowing the filling material composition introduced in (3) to react. In this process, the composition which is applied in step (1) is the spray polyurethane-urea elastomer described above. The polyurethane filling material will preferably form a bonding layer with the elastomeric layer. The molded composite is removed from the mold once the filling-material reaction is completed.

The polyurethane filling composition can be any of the known:

soft foams with high or low resilience
rigid foams
rigid or flexible integral foams or
compact materials with or without reinforcing materials like fillers, microspheres or fibers.

Soft high resilience foams typically exhibit a low molded density preferred from 25 to 100 g/l and a preferred compression hardness below 20 kPa [DIN EN ISO 3386] and a preferred rebound resilience higher than 20% [DIN EN ISO 8307].

Soft low resilience foams typically exhibit a low molded density preferred from 25 to 100 g/l and a preferred compression hardness below 20 kPa and a preferred rebound resilience lower than 20%.

Rigid foams typically exhibit a low molded density, preferably from 25 to 400 g/l and a preferred compression hardness higher than 50 kPa [DIN EN 826]. They are preferably produced at a ratio of the total number of isocyanate groups present to the total number of isocyanate reactive groups from about 1.0 to 5.0.

Rigid integral foams with or without skin typically exhibit a preferred molded density from 100 to 1200 g/l, a preferred hardness from 80 Shore A to 90 Shore D [DIN 35505], and a preferred elongation at break of less than 20%.

Flexible integral foams with or without skin typically exhibit a preferred molded density from 100 to 800 g/l, a preferred hardness from 15 to 80 Shore A, and a preferred elongation at break from 100 to 400% [DIN 53504].

Compact materials typically exhibit a preferred density from 800 to 1200 g/l, a preferred hardness from 70 Shore A to 90 Shore D and a preferred modulus of elasticity of 300 to 8000 N/mm² [EN ISO 178]. These materials can be reinforced with chopped glass or carbon fibers, inorganic fillers, nanoparticles, fiber mats or other reinforcing materials.

It is also possible for the filling material composition to be introduced into the mold before the mold is closed. However, it is still necessary to close the mold prior to completion of filling material formation. As above, the molded composite is removed from the mold after the filling material reaction is completed.

In an alternative method, a composite is produced in a mold by (1) applying, preferably by spraying, an elastomer composition over the surface of the mold cavity and allowing the elastomer composition to at least partially cure to form an elastomeric layer, (2) introducing a filling material composition into the mold cavity and applying the filling material composition to the at least partially cured elastomeric layer to form a backing layer on the component, and (3) demolding the resulting composite. In this aspect of the present invention, the elastomer composition applied in (1) is the spray elastomer composition described above.

Optional embodiments of the above described alternative methods include forming decorative composites or colored/pigmented composites. This can be accomplished, for example, by first applying a light stable polyurethane coating composition having the desired color or pigment to the inside surface of the mold cavity, and proceeding as described above in steps (1)-(3) or steps (1)-(4).

It is also possible to prepare these decorative components by first applying a first coating having the desired color or pigment to the inside surface of the mold cavity, and then applying, preferably by spraying, an elastomer composition over the surface of the mold cavity and allowing the elastomer composition to at least partially cure to form an elastomeric layer, and demolding the decorative component. A polyurethane foam forming composition can then be applied to the elastomeric layer to form a backing layer. Subsequent coating applications can be applied over the first coating too, if desired.

Decorative components can also be made by applying a coating composition having the desired color or pigment to the elastomeric layer after demolding the molded composite. This process requires completing steps (1)-(3) or (1)-(4) as described above first, and coating the outer elastomeric layer of the composite with a coating containing the desired colorant or pigment.

In a further alternative, the elastomeric layer is applied, preferably by spraying, onto the surface of three dimensionally shaped parts. Such parts are made by any of the above-mentioned polyurethane filling materials.

Sprayable elastomers of the present invention comprise the reaction product of:
(A) a polyisocyanate and/or NCO-prepolymer and/or modified polyisocyanate thereof with an isocyanate content from about 6 to about 20%, preferably from about 8 to about 16% and most preferably from about 9 to about 13%;
with
(B) an isocyanate-reactive component comprising:
   (1) from about 70 to about 99%, preferably 80 to 99%, most preferably 85 to 99% by weight, based on 100% of the combined weight of components (1) and (2), of one or more compounds containing from about 1.5 to about 6, preferably from about 1.8 to about 3.5 isocyanate-reactive groups (may be any NCO-reactive group including OH, SH, etc., is preferably OH) other than primary or secondary NH groups, having a number average molecular weight of from about 60 to about 8000, preferably from 60 to about 6000 and an OH number of from about 14 to about 1870, preferably from about 28 to 1870;
   and
   (2) from about 1 to about 30%, preferably 1 to 20%, most preferably 1 to 15% by weight, based on 100% of the combined weight of components (1) and (2), of one or more compounds containing from about 1.5 to about 4 primary or secondary amine groups, having a number average molecular weight of from about 60 to about 500, and an NH number of from about 225 to about 1870,
and optionally:
(C) one or more catalysts,
(D) one or more anti-oxidants,
(E) one or more UV stabilizers,
and
(F) one or more colorants,
   in which the ratio of the total number of isocyanate groups present to the total number of isocyanate-reactive groups present is from about 0.80:1 to about 1.20:1. In these sprayable elastomers, it is preferred that the ratio of the total number of isocyanate groups present to the total number of isocyanate-reactive groups present be from about 0.90:1 to about 1.10:1, and most preferably from about 0.95:1 to about 1.05:1. These elastomers do not require an internal mold release agent.

Suitable polyisocyanates and/or prepolymers or modified polyisocyanates thereof to be used as component (A) in the present invention typically have NCO group contents from about 6 to about 20%. These polyisocyanates and/or prepolymers and/or modified polyisocyanates typically have NCO group contents of at least about 6%, preferably at least about 8% and most preferably at least about 9%. The polyisocyanates and/or prepolymers and/or modified polyisocyanates suitable herein also typically have NCO group contents of less than or equal to 20%, preferably of less than or equal to 16% and most preferably of less than or equal to 13%. The polyisocyanates and/or prepolymers and/or modified polyisocyanates may have an NCO group content ranging between any combination of these upper and lower values, inclusive, e.g., from 6 to 20%, preferably from 8 to 16% and most preferably from 9 to 13%.

Suitable polyisocyanates and/or prepolymers and/or modified polyisocyanates thereof are based on diphenylmethane diisocyanates and polyphenylmethane polyisocyanates which have the above-disclosed NCO group contents. It is preferred that the polyisocyanate component comprise 100% by weight of diphenylmethane diisocyanate and 0% by weight of polyphenylmethane polyisocyanate, with the sum totaling 100% of the polyisocyanate.

These polyisocyanates typically have a monomeric MDI content of at least about 50%, preferably of at least about 75%, more preferably of at least about 85% and most preferably of at least about 95%. The polyisocyanates also typically have a monomeric MDI content which is less than or equal to about 100%. These polyisocyanates may have a monomeric MDI content ranging between any combination of these upper and lower values, inclusive, e.g., from 50 to 100%, preferably from 75 to 100%, more preferably from 85 to 100% and most preferably from 95 to 100%.

In addition, these polyisocyanates may have a polymeric MDI content as low as 0%. The polyisocyanates typically have a polymeric MDI content of less than or equal to about 50%, preferably less than or equal to about 25%, more preferably less than or equal to about 15% and most preferably less than or equal to about 5%. These polyisocyanates may have a polymeric MDI content ranging between any combination of these upper and lower values, inclusive, e.g., from 0 to 50%, preferably from 0 to 25%, more preferably from 0 to 15% and most preferably from 0 to 5%.

Suitable polyisocyanates having the above-described monomeric MDI contents, typically have an isomer distribution of 2,2′-, 2,4′- and 4,4′-MDI as follows. The % by weight of (1) the 2,4′-isomer of diphenylmethane diisocyanate is typically at least about 2%, preferably at least about 10%, more preferably at least about 25% and most preferably at least about 40%. The % by weight of (1) the 2,4′-isomer generally is about 60% or less, and most preferably of about 55% or less. The diphenylmethane diisocyanate component may have (1) a 2,4′-isomer content ranging between any of these upper and lower values, inclusive, e.g., from 2 to 60%, preferably from 10 to 60%, more preferably from 25 to 60% and most preferably from 40 to 55%. The % by weight of the (2) 2,2′-isomer of diphenylmethane diisocyanate is typically at least about 0%, and preferably about 0%. The % by weight of (2) the 2,2′-isomer generally is about 5% or less, preferably of about 2% or less. The diphenylmethane diisocyanate component may have (2) a 2,2′-isomer content ranging between any of these upper and lower values, inclusive, e.g., from 0 to 5%, and preferably from 0 to 2%. The % by weight of (3) the 4,4′-isomer of diphenylmethane diisocyanate is typically at least about 40%, preferably at least about 45%. The % by weight of (3) the 4,4′-isomer generally is about 98% or less, preferably of about 90% or less, more preferably of about 75% or less, and most preferably of about 60% or less. The diphenylmethane diisocyanate component may have (3) a 4,4′-isomer content ranging between any of these upper and lower values, inclusive, e.g., from 40 to 98%, preferably from 40 to 90%, more preferably from 40 to 75% and most preferably from 45 to 60%. The %'s by weight of the isomers (1), (2) and (3) always total 100% by weight of the monomeric diphenylmethane diisocyanate.

In the embodiment of the present invention in which (A) the isocyanate component includes an isocyanate-terminated prepolymer, the prepolymer is typically prepared by reacting a suitable polyisocyanate component as described above, with an isocyanate-reactive component such that the resultant prepolymer has an NCO group content as described herein above. The prepolymer may have an NCO group content ranging between any combination of these upper and lower values, inclusive, e.g., as previously described. Generally, the relative amounts of polyisocyanate and isocyanate-reactive component are such that there is an excess of NCO groups present.

Suitable prepolymers will also typically have a functionality of at least about 1.5, and most preferably at least about 2. These prepolymers typically have a functionality of less than or equal to 3, preferably less than or equal to 2.5 and most preferably less than or equal to 2.1. The prepolymer may have a functionality ranging between any combination of these upper and lower values, inclusive, e.g., of from about 1.5 to about 3, preferably from about 2 to about 2.5 and most preferably from about 2 to about 2.1.

The urethane group content of these prepolymers is typically at least about 0.1%, more preferably at least about 0.2% and most preferably at least about 0.3%. These prepolymers typically have a urethane group content of less than or equal to 5%, preferably less than or equal to 3.5% and most preferably less than or equal to 2.8%. The prepolymer may have a urethane group content ranging between any combination of these upper and lower values, inclusive, e.g., of from about 0.1% to about 5%, preferably from about 0.2% to about 3.5% and most preferably from about 0.3% to about 2.8%.

These prepolymers useful in the practice of the present invention typically have a viscosity of at least about 100 mPa·s, more preferably at least about 200 mPa·s and most preferably at least about 500 mPa·s. These prepolymers typically have a viscosity of less than or equal to 10,000 mPa·s, preferably less than or equal to 5,000 mPa·s and most preferably less than or equal to 3,000 mPa·s. The prepolymer may have a viscosity ranging between any combination of these upper and lower values, inclusive, e.g., of from about 100 to about 10,000 mPa·s, preferably from about 200 to about 5,000 mPa·s and most preferably from about 500 to about 3,000 mPa·s.

In making the prepolymers, any of the previously described polyisocyanates based on diphenylmethane diisocyanate, polymethylene polyphenyl-isocyanates and mixtures thereof are suitable. The isocyanate-reactive component is, generally speaking, an organic compound which contains at least about 1.5, preferably at least about 1.8 and most preferably at least about 1.9 functional groups which are capable of reacting with the isocyanate groups. These compounds also typically contain less than or equal to about 3, preferably less than or equal to about 2.5 and most preferably less than or equal to about 2.3 functional groups which are capable of reacting with the isocyanate groups. The isocyanate-reactive component may contain a number of functional groups ranging between any combination of these upper and lower values, inclusive, e.g., from 1.5 to 3, preferably from 1.8 to 2.5 and most preferably from 1.9 to 2.3. Suitable isocyanate-reactive groups include OH groups, NH groups, SH groups, etc., with OH groups being particularly preferred.

Suitable number average molecular weight ranges for these isocyanate-reactive compounds to be used in preparation of the prepolymers are at least about 200, preferably at least about 500 and most preferably at least about 1,000. These compounds also typically have a molecular weight of less than or equal to about 8,000, preferably less than or equal to about 6,000 and most preferably less than or equal to about 3,000. The isocyanate-reactive component may have a molecular weight ranging between any combination of these upper and lower values, inclusive, e.g., from 200 to 8,000, preferably from 500 to 6,000 and most preferably from 1,000 to 3,000.

Suitable compounds useful as the isocyanate-reactive component to be used in preparation of the prepolymers include, but are not limited to, polyether polyols, polyester polyol, polycarbonate diols, polyhydric polythioethers, polyacetals, aliphatic thiols, etc. Preferred isocyanate-reactive components for making the prepolymer are polyether polyols. Obviously, these preferred polyether polyols must satisfy the above-described limits in terms of both molecular weight and functionality.

In the embodiment of the present invention in which (A) the isocyanate component includes a mixture of polyisocyanates and/or prepolymers and/or modified polyisocyanates, the modified isocyanates typically contain carbodiimide-, uretonimine-, allophanate-, isocyanurate-, urea- or biuret functionalities derived from 4,4′- and/or 2,4′ and/or 2,2′-diphenylmethanediisocyanate.

A particularly preferred isocyanate to be used as component (A) in the present invention includes an isocyanate-terminated prepolymer having an NCO content of from about 6 to about 20%, preferably from about 8 to 16% and most preferably from about 9 to 13%; a functionality of from about 1.5 to 3, preferably from about 1.8 to about 2.5 and most preferably from about 1.8 to about 2.3; and a viscosity of from about 100 to about 10,000 mPa·s, preferably from about 200 to about 5,000 mPa·s and most preferably from about 2,000 to about 3,000 mPa·s at 25° C. Such prepolymers can be prepared by reacting: i) from about 50 to about 150, preferably about 75 to about 125 and most preferably about 100 parts by weight of distilled 2,4′-isomer rich MDI having an NCO content of about 30 to about 33.6%, preferably about 32 to about 33.6% and most preferably about 33 to about 33.6%; a functionality of about 2.0 to about 2.3, preferably about 2.0 to about 2.1 and most preferably about 2.0; a viscosity of about 25 to about 180, preferably about 25 to about 100 and most preferably about 25 to about 50 mPa·s at 25° C.; and having an isomer distribution of about 44 to about 98%, preferably about 44 to about 70% and most preferably about 44 to about 60% by wt. of the 4,4′-isomer, from about 2 to about 54%, preferably about 30 to about 54% and most preferably about 40 to about 54% by wt. of the 2,4′-isomer, and from 0 to about 5%, preferably about 0.2 to about 2.5% and most preferably about 0.5 to about 2% by wt. of the 2,2′-isomer, and optionally, a modified polyisocyanate of the type described above can be used from 1 to about 20% by weight, preferably, from 1-15% by weight and most preferably, from 1 to about 10% by weight, with ii) from about 100 to about 250, preferably from about 150 to about 200 and most preferably from about 160 to about 170 parts by weight of a polyether polyol (most preferably one initiated from propylene glycol with propylene oxide) having a molecular weight of from about 200 to about 8,000, preferably from about 500 to about 6,000 and most preferably about 1,000 to about 3,000; having a functionality of from about 1.5 to about 3, preferably from about 1.8 to about 2.5 and most preferably of about 2.

It is most particularly preferred embodiment of the invention, the prepolymers have an NCO group content of from about 9 to about 13%, a functionality of about 1.8 to about 2.3, a urethane content of from about 0.2 to about 3%, and a viscosity of from about 2,000 to about 3,000 mPa·s at 25° C.

Suitable isocyanate-reactive components to be used as (B) in the present invention include (1) one or more compounds containing isocyanate-reactive groups, excluding primary and/or secondary NH groups, and (2) one or more compounds containing from about 1.5 to about 6 primary and/or secondary amine groups.

Suitable isocyanate-reactive groups for component (B)(1) typically include OH groups, SH groups, etc. Compounds containing virtually any type of reactive group which is capable of reaction with an NCO group from the polyisocyanate component (A) are suitable for use as component (B)(1), provided that they satisfy the requirements in terms of molecular weight, number of functional groups, OH number, etc. as set forth below. Obviously, components (B)(1) and (B)(2) are mutually exclusive, so (B)(1) compounds will, in general, not contain primary and/or secondary NH groups as these compounds are within the scope of (B)(2). In a preferred embodiment, component (B)(1) contains OH or SH groups, and most preferably OH groups.

Suitable compounds to be used as component (B)(1) in accordance with the present invention typically contain at least about 1.5 isocyanate-reactive groups, most preferably at least about 2 isocyanate-reactive groups. These compounds also typically contain no more than about 6 isocyanate-reactive groups, more preferably no more than about 4 and most preferably no more than about 3 isocyanate-reactive groups. It is also possible that these compounds have any number of isocyanate-reactive groups ranging between any combination of these upper and lower values, inclusive, e.g., from about 1.5 to about 6, more preferably from 2 to 4 and most preferably from about 2 to about 3.

Suitable compounds to be used as component (B)(1) in accordance with the present invention typically have a molecular weight (number average of at least about 60. These compounds also typically have a molecular weight (number average) of less than or equal to about 8,000, more preferably less than or equal to about 7,000 and most preferably less than or equal to about 6,000. It is also possible that these compounds have any molecular weight ranging between any combination of these upper and lower values, inclusive, e.g., from about 60 to about 8,000, more preferably from about 60 to about 7,000 and most preferably from about 60 to about 6,000.

Suitable compounds to be used as component (B)(1) in accordance with the present invention typically have an OH number of at least about 14, more preferably at least about 20 and most preferably at least about 28. These compounds also typically have an OH number no greater than about 1870. It is also possible that these compounds have any OH number ranging between any combination of these upper and lower values, inclusive, e.g., from about 14 to about 1870, more preferably from about 20 to about 1870 and most preferably from about 28 to about 1870.

Examples of suitable compounds to be used as component (B)(1) in the present invention include components, which include, for example, those compounds referred to as chain extenders and/or crosslinkers, such as low molecular weight glycols like ethylene glycol, 1,2- or 1,3-propanediol, 1,2-, 1,3-, or 1,4-butanediol, glycerin, trimethylolpropane, pentaerythritol, ethanolamine, triethanolamine.

Further examples of suitable compounds to be used as component (B)(1) in the present invention include compounds such as, for example, polyether polyols, polyester polyols, polycarbonate diols, polyhydric polythioethers, polyacetals, aliphatic thiols, solids containing polyols including those selected from the group consisting of graft polyols, polyisocyanate polyaddition polyols, polymer polyols, PHD polyols and mixtures thereof, etc. Lower molecular weight polyether polyols are also suitable for component (B)(1), provided they are within the ranges set forth above for functionality, molecular weight and OH number, and satisfy the requirements for types of isocyanate-reactive groups. It is preferred to use a polyether polyol as (B)(1).

Hydroxyl-containing polyethers are particularly suitable for use as isocyanate-reactive component (B)(1). Suitable hydroxyl-containing polyethers can be prepared, for example, by the polymerization of epoxides such as ethylene oxide, propylene oxide, butylene oxide, tetrahydrofuran, styrene oxide, or epichlorohydrin, optionally in the presence of BF₃, or by chemical addition of such epoxides, optionally as mixtures or successively, to starting components containing reactive hydrogen atoms, such as water, alcohols, or amines. Examples of such starting components include: ethylene glycol, 1,2- or 1,3-propanediol, 1,2-, 1,3-, or 1,4-butanediol, glycerin, trimethylolpropane, pentaerythritol, 4,4′-dihydroxydiphenyl-propane, aniline, 2,4- or 2,6-diaminotoluene, ammonia, ethanolamine, triethanolamine, and/or ethylene diamine. Sucrose polyethers of the type described, for example, in German Auslegeschriften 1,176,358 and 1,064,938 may also be used in the practice of the present invention. Polyethers that contain predominantly primary hydroxyl groups (up to about 90% by weight, based on all of the hydroxyl groups in the polyether) are particularly preferred. Polyethers modified by vinyl polymers of the type obtained, for example, by the polymerization of styrene and acrylonitrile in the presence of polyethers (e.g., U.S. Pat. Nos. 3,383,351; 3,304,273; 3,523,093; and 3,110,695 and German Patentschrift 1,152,536) are also suitable, as are polybutadienes containing hydroxyl groups. Particularly preferred polyethers include: polyoxyalkylene polyether polyols, such as polyoxyethylene diol and triol, polyoxypropylene diol and triol, and polyoxypropylene diols and triols that have been capped with polyoxyethylene blocks.

Hydroxyl-containing polyesters are also suitable for use as isocyanate-reactive component (B)(1). Suitable hydroxyl-containing polyesters include the reaction products of polyhydric alcohols (preferably diols), optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters useful in the practice of the present invention. The polycarboxylic acids may be aliphatic, cycloaliphatic, aromatic, or heterocyclic and may be substituted, e.g., by halogen atoms, and/or unsaturated bonds. Suitable polycarboxylic acids include: succinic acid, adipic acid, suberic acid, azelaic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids, dimethyl terephthalic, and terephthalic acid bis-glycol esters. Suitable polyhydric alcohols include: ethylene glycol, 1,2- and 1,3-propanediol, 1,4- and 2,3-butanediol, 1,6-hexanediol, 1,8-octanediol, neopentyl glycol, 1,3- and 1,4-bis(hydroxymethyl) cyclohexane, 2-methyl-1,3-propanediol, glycerol, trimethylolpropane, 1,2,6-hexanetriol, 1,2,4-butanetriol, trimethylolethane, pentaerythritol, quinitol, mannitol, sorbitol, methyl glycoside, diethylene glycol, triethylene glycol, tetraethylene glycol, polyethylene glycols, dipropylene glycol, polypropylene glycols, dibutylene glycol, and polybutylene glycols. The polyesters may also contain a proportion of carboxyl end groups. Polyesters of lactones, such as ε-caprolactone, or of hydroxycarboxylic acids, such as ω-hydroxycaproic acid, may also be used. Hydrolytically stable polyesters are preferably used in order to obtain the greatest benefit relative to the hydrolytic stability of the final product. Preferred polyesters include polyesters obtained from adipic acid or isophthalic acid and straight chained or branched diols, as well as lactone polyesters, preferably those based on caprolactone and diols.

Suitable polyacetals include compounds obtained from the condensation of glycols, such as diethylene glycol, triethylene glycol, 4,4′-dihydroxydiphenylmethane, and hexanediol, with formaldehyde or by the polymerization of cyclic acetals, such as trioxane.

Suitable polycarbonates include those prepared by the reaction of diols, such as 1,3-propanediol, 1,4-butanediol, 1,6-hexanediol, diethylene glycol, triethylene glycol, tetraethylene glycol, or thiodiglycol, with phosgene or diaryl carbonates such as diphenyl carbonate (German Auslegeschriften 1,694,080; 1,915,908; and 2,221,751; German Offenlegungsschrift 2,605,024).

Suitable polyester carbonates include those prepared by the reaction of polyester diols, with or without other diols such as 1,3-propanediol, 1,4-butanediol, 1,6-hexanediol, diethylene glycol, triethylene glycol, tetraethylene glycol, or thiodiglycol, with phosgene, cyclic carbonates, or diaryl carbonates such as diphenyl carbonate. Suitable polyester carbonates more generally include compounds such as those disclosed in U.S. Pat. No. 4,430,484.

Suitable polythioethers include the condensation products obtained by the reaction of thiodiglycol, either alone or with other glycols, formaldehyde, or amino alcohols. The products obtained are polythio-mixed ethers, polythioether esters, or polythioether ester amides, depending on the components used.

Although less preferred, other suitable hydroxyl-containing compounds include polyhydroxyl compounds already containing urethane or urea groups and modified or unmodified natural polyols. Products of addition of alkylene oxides to phenol-formaldehyde resins or to urea-formaldehyde resins are also suitable. Furthermore, amide groups may be introduced into the polyhydroxyl compounds as described, for example, in German Offenlegungsschrift 2,559,372.

General discussions of representative hydroxyl-containing compounds that may be used according to the present invention can be found, for example, in Polyurethanes, Chemistry and Technology by Saunders and Frisch, Interscience Publishers, New York, London, Volume I, 1962, pages 32-42 and pages 44-54, and Volume II, 1964, pages 5-6 and 198-199, and in Kunststoff-Handbuch, Volume VII, Vieweg-Hochtlen, Carl-Hanser-Verlag, Munich, 1966, on pages 45 to 71.

Other suitable hydroxyl-containing polyethers include those polyethers which have low molecular weights, i.e. from about 60 to less than about 399. Suitable hydroxyl-containing polyethers can be prepared, for example, by the methods discussed above for the hydroxy-containing polyethers except that only lower molecular weight polyethers are used. Particularly suitable polyethers include polyoxyalkylene polyether polyols, such as polyoxyethylene diol, polyoxypropylene diol, polyoxybutylene diol, and polytetramethylene diol having the requisite molecular weights.

Suitable compounds to be used as component (B)(2) in accordance with the present invention typically contain at least about 1.5 amine groups, preferably primary or secondary amine groups, more preferably at least about 1.8 and most preferably at least about 2 amine groups. These compounds also typically contain no more than about 4 amine groups, more preferably no more than about 3 and most preferably no more than about 2.1 amine groups. It is also possible that these compounds have any number of isocyanate-reactive groups ranging between any combination of these upper and lower values, inclusive, e.g., from about 1.5 to about 4, more preferably from about 1.8 to about 3, and most preferably from about 2 to about 2.1.

Suitable compounds to be used as component (B)(2) in accordance with the present invention typically have a molecular weight of at least about 60, more preferably at least about 100 and most preferably at least about 150. These compounds also typically have a molecular weight which is less than or equal to about 500, more preferably less than or equal to about 400 and most preferably less than or equal to about 300. It is also possible that these compounds have any of the molecular weights ranging between any combination of these upper and lower values, inclusive, e.g., from 60 to 500, more preferably from 100 to 400 and most preferably from 150 to 300.

Suitable compounds to be used as component (B)(2) in accordance with the present invention typically have an NH number of at least about 225, more preferably at least about 280 and most preferably at least about 370. These compounds also typically have an NH number of less than or equal to about 1870, more preferably less than or equal to about 1120 and most preferably less than or equal to about 750. It is also possible that these compounds have any NH number ranging between any combination of these upper and lower values, inclusive, e.g., from about 225 to about 1870, more preferably from about 280 to about 1120 and most preferably from about 370 to about 750.

Suitable isocyanate-reactive compounds containing amino groups include the so-called amine-terminated polyethers containing primary or secondary (preferably primary) aromatically or aliphatically (preferably aliphatically) bound amino groups. Compounds containing amino end groups can also be attached to the polyether chain through urethane or ester groups. These amine-terminated polyethers can be prepared by any of several methods known in the art. For example, amine-terminated polyethers can be prepared from polyhydroxyl polyethers (e.g., polypropylene glycol ethers) by a reaction with ammonia in the presence of Raney nickel and hydrogen (Belgian Patent 634,741). Polyoxyalkylene polyamines can be prepared by a reaction of the corresponding polyol with ammonia and hydrogen in the presence of a nickel, copper, chromium catalyst (U.S. Pat. No. 3,654,370). The preparation of polyethers containing amino end groups by the hydrogenation of cyanoethylated polyoxypropylene ethers is described in German Patentschrift 1,193,671. Other methods for the preparation of polyoxyalkylene (polyether) amines are described in U.S. Pat. Nos. 3,155,728 and 3,236,895 and in French Patent 1,551,605. French Patent 1,466,708 discloses the preparation of polyethers containing secondary amino end groups. Also useful are the polyether polyamines described in U.S. Pat. Nos. 4,396,729, 4,433,067, 4,444,910, and 4,530,941, the disclosures of which are herein incorporated by reference.

Aminopolyethers obtained by the hydrolysis of compounds containing isocyanate end groups are also preferred amine-terminated polyethers. For example, in a process disclosed in German Offenlegungsschrift 2,948,419, polyethers containing hydroxyl groups (preferably two or three hydroxyl groups) react with polyisocyanates to form isocyanate prepolymers whose isocyanate groups are then hydrolyzed in a second step to amino groups. Preferred amine-terminated polyethers are prepared by hydrolyzing an isocyanate compound having an isocyanate group content of from 0.5 to 40% by weight. The most preferred polyethers are prepared by first reacting a polyether containing two to four hydroxyl groups with an excess of an aromatic polyisocyanate to form an isocyanate terminated prepolymer and then converting the isocyanate groups to amino groups by hydrolysis. Processes for the production of useful amine-terminated polyethers using isocyanate hydrolysis techniques are described in U.S. Pat. Nos. 4,386,218; 4,456,730; 4,472,568; 4,501,873; 4,515,923; 4,525,534; 4,540,720; 4,578,500; and 4,565,645, European Patent Application 97,299, and German Offenlegungsschrift 2,948,419, the disclosures of which are each herein incorporated by reference. Similar products are also described in U.S. Pat. Nos. 4,506,039; 4,525,590; 4,532,266; 4,532,317; 4,723,032; 4,724,252; 4,855,504; and 4,931,595, the disclosures of which are each herein incorporated by reference.

Other suitable amine-terminated polyethers include aminophenoxy-substituted polyethers described, for example, in European Patent Applications 288,825 and 268,849. Aminophenoxy-substituted polyethers can also be prepared, for example, by converting polyether polyols into nitrophenoxy-terminated polyethers (by reaction, for example, with chloronitrobenzenes), followed by hydrogenation. (See, e.g., U.S. Pat. Nos. 5,079,225 and 5,091,582.) In a preferred method, aminophenoxy-substituted polyethers are prepared by converting polyether polyols into the corresponding sulfonate derivatives, followed by reaction of the polyether sulfonate with an aminophenoxide.

The amine-terminated polyethers used in the present invention are in many cases mixtures with other isocyanate-reactive compounds having the appropriate molecular weight. These mixtures generally should contain (on a statistical average) two to four isocyanate reactive amino end groups.

Aminocrotonate-terminated derivatives of polyethers, as well as of other polyols described above, can be prepared from acetoacetate-modified polyethers as described, for example, in U.S. Pat. Nos. 5,066,824, and 5,151,470, the disclosures of which are herein incorporated by reference.

Amine chain extenders preferably contain primary and less preferred secondary amino groups. Examples of aromatic diamines include: 1,4-diaminobenzene, 2,4- and/or 2,6-diaminotoluene, 2,4′ and/or 4,4′-diaminodiphenylmethane, 3,3′-dimethyl-4,4′-diaminodiphenylmethane, 1-methyl-3,5-bis(methylthio)-2,4- and/or -2,6-diaminobenzene, 1,3,5-triethyl-2,4-diaminobenzene, 1,3,5-triisopropyl-2,4-diaminobenzene, 1-methyl-3,5-diethyl-2,4- and/or -2,6-diaminobenzene, 4,6-dimethyl-2-ethyl-1,3-diaminobenzene, 3,5,3′, 5′-tetraethyl-4,4-diaminodiphenylmethane, 3,5,3′, 5′-tetraisopropyl-4,4′-diaminodiphenylmethane, and 3,5-diethyl-3′,5′-diisopropyl-4,4′-diaminodiphenylmethane. Suitable aliphatic diamines include: 1,3-bis(aminomethyl)cyclohexane, m-xylylenediamine, 1,3,3-trimethyl-5-aminocyclohexanemethylamine, 4,4′-methylene bis(cyclohexylamine), diethylamine, hexamethylendiamine, etc. Particularly suitable diamines are 1-methyl-3,5-diethyl-2,4- and/or -2,6-diaminobenzene, m-xylylenediamine, 1,3,3-trimethyl-5-aminocyclohexanemethylamine and 4,4′-methylene bis(cyclohexylamine). Such diamines may, of course, also be used as mixtures.

Suitable catalysts, when present, to be used as component (C) in accordance with the present invention, include, for example, various catalysts such as known amine catalysts and other catalysts capable of promoting the reaction between polyisocyanates (A) and isocyanate-reactive components (B).

Suitable catalysts (C) include tertiary amines and metal compounds known in the art. Suitable tertiary amine catalysts include: triethylamine, tributylamine, N-methylmorpholine, N-ethylmorpholine, N,N,N′,N′-tetramethylethylene diamine, pentamethyldiethylene triamine, and higher homologs (German Offenlegungsschriften 2,624,527 and 2,624,528), 1,4-diazabicyclo[2.2.2]octane, N-methyl-N′-(dimethylaminoethyl)piperazine, bis(dimethylaminoalkyl)piperazines (German Offenlegungsschrift 2,636,787), N,N-dimethylbenzylamine, N,N-dimethylcyclohexyl amine, N,N-diethylbenzylamine, bis(N,N-diethylaminoethyl) adipate, N,N,N′,N′-tetramethyl-1,3-butanediamine, N,N-dimethyl-.beta.-phenylethylamine, 1,2-dimethylimidazole, 2-methylimidazole, monocyclic and bicyclic amidines (German Offenlegungsschrift 1,720,633), bis(dialkylamino)alkyl ethers (U.S. Pat. No. 3,330,782, German Auslegeschrift 030,558, and German Offenlegungsschriften 1,804,361 and 2,618,280), and tertiary amines containing amide groups (preferably formamide groups) according to German Offenlegungsschriften 2,523,633 and 2,732,292. The catalysts used may also be the known Mannich bases of secondary amines (such as dimethylamine) and aldehydes (preferably formaldehyde) or ketones (such as acetone) and phenols. Particularly preferred catalysts are those which are commercially available under the names Dabco® 33LV and Dabco® 1028 from Air Products Corp.

Suitable catalysts also include certain tertiary amines containing isocyanate reactive hydrogen atoms. Examples of such catalysts include: triethanolamine, triisopropanolamine, N-methyldiethanolamine, N-ethyldiethanolamine, N,N-dimethylethanolamine, their reaction products with alkylene oxides (such as propylene oxide and/or ethylene oxide) and secondary-tertiary amines according to German Offenlegungsschrift 2,732,292.

Other suitable catalysts include acid blocked amines (i.e., delayed action catalysts). Examples of acid-blocked amine catalysts include those which are commercially available under the names DABCO® 8154 catalyst based on 1,4-diazabicyclo[2.2.2]octane and DABCO® BL-17 catalyst based on bis(N,N-dimethylaminoethyl) ether (available from Air Products and Chemicals, Inc., Allentown, Pa.) and POLYCAT® SA-1, POLYCAT® SA-102, and POLYCAT® SA-610/50 catalysts based on POLYCAT® DBU amine catalyst (available from Air Products and Chemicals, Inc.) as are known and described in, for example, U.S. Pat. No. 5,973,099, the disclosure of which is herein incorporated by reference.

Examples of suitable organic acid-blocked amine gel catalysts which may be employed are the acid-blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2 dimethyl imidazole, and dimethyl cyclohexylamine. The blocking agent can be an organic carboxylic acid having 1 to 20 carbon atoms, preferably 1-2 carbon atoms. Examples of blocking agents include 2-ethyl-hexanoic acid and formic acid. Any stoichiometric ratio can be employed with one acid equivalent blocking one amine group equivalent being preferred. The tertiary amine salt of the organic carboxylic acid can be formed in situ, or it can be added to the polyol composition ingredients as a salt. To this end, quaternary ammonium salts are particularly useful. Such acid blocked amine catalysts are known and described in, for example, U.S. Pat. No. 6,013,690, the disclosure of which is herein incorporated by reference.

Still other suitable amine catalysts include the organic acid blocked tertiary amines. Suitable organic carboxylic acids used to block the tertiary amine gel catalysts, if needed to provide a time delayed action, include mono- or dicarboxylic acids having 1-20 carbon atoms, such as formic, acetic, propionic, butyric, caproic, 2-ethyl-hexanoic, caprylic, cyanoacetic, pyruvic, benzoic, oxalic, malonic, succinic, and maleic acids, with formic acid being preferred. The organic acid blocked tertiary amine gel catalysts are usually dissolved in water or organic solvents to avoid separation of the salt as crystals and the resultant phase separation. Preferable organic solvents include polyols having 2 to 4 hydroxyl groups in the molecule, such as ethylene glycol, diethylene glycol, propylene glycol, dipropylene glycol, butanediols, 2,6-hexanediol and glycerine. Among the listed compounds, the most frequently used are ethylene glycol, diethylene glycol, propylene glycol, dipropylene glycol and 1,4-butanediol.

The delayed action gel catalysts may be fully blocked or partially blocked with an organic carboxylic acid to yield a fully blocked tertiary amine salt of the organic carboxylic acid or a partially blocked salt of the organic carboxylic acid. The amount of organic carboxylic acid to be reacted with the tertiary amine gel catalyst depends upon the degree to which one desires to delay the tertiary amine catalytic activity. A fully blocked tertiary amine gel catalyst will have at least a 1:1 molar ratio of carboxylic acid equivalents to amine group equivalents. It is preferred that the tertiary amine gel catalyst be fully blocked within the polyol composition. In those cases where the delayed action feature is attributable to carboxylic acid blocking, it is also preferred that the tertiary amine gel catalyst be blocked prior to addition into the polyol composition. Although it is within the scope of the invention that a fast acting gel catalyst may be added to the polyol composition along with a desired stoichiometric amount of formic acid separately added, this embodiment is not preferred because kinetically the formic acid may not find and bond to each gel catalyst molecule and/or may bond to amine initiated polyether polyols present in the polyol composition. Acid blocked amine catalysts such as these are described in for example, U.S. Pat. No. 5,789,533, the disclosure of which is herein incorporated by reference.

Other acid blocked amine catalysts suitable for the present invention include those described in, for example U.S. Pat. Nos. 4,219,624, 5,112,878, 5,183,583, 6,395,796, 6,432,864 and 6,525,107, the disclosures of which are herein incorporated by reference.

Other suitable catalysts include organic metal compounds, especially organic tin, bismuth, and zinc compounds. Suitable organic tin compounds include those containing sulfur, such as dioctyl tin mercaptide (German Auslegeschrift 1,769,367 and U.S. Pat. No. 3,645,927), and, preferably, tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versatate, and various bismuth carboxylates known in the art. Suitable zinc compounds include zinc neodecanoate and zinc versatate. Mixed metal salts containing more than one metal (such as carboxylic acid salts containing both zinc and bismuth) are also suitable catalysts.

Suitable anti-oxidants for use as component (D) in the present invention include, but are not limited to, those commercially available anti-oxidants such as that which is sold under the name UVINUL® A03 (available from BASF Corporation) and those which are sold under the names IRGANOX® 1010, IRGANOX® 1135 and IRGANOX® 1098 (all of which are available from Ciba Specialty Chemicals Corporation). The anti-oxidants may be used in amounts of up to 2.0 weight percent of the total weight of the elastomeric composition, with 0.25 weight percent to 1.0 weight percent being preferred.

Suitable UV stabilizers for use as component (E) in the present invention include, for example, those which are commercially available under the names Tinuvin® 144, Tinuvin® 213, Tinuvin® 292, Tinuvin® 328, Tinuvin® 765, and Tinuvin® 770 (all of which are commercially available from Ciba Specialty Chemicals Corporation). The UV light stabilizer may be used in an amount of up to 2.0 weight % of the total weight of the elastomeric composition, with 0.25 weight % to about 1.0 weight % being preferred.

Suitable colorants to be used as component (F) in the present invention include, for example, various coloring pigments and dyes such as carbon black, solvent black, titanium dioxide and the like.

Other suitable additives and auxiliary agents to be included in the present invention include, for example, molecular sieves (e.g., Baylith paste which is commercially available from Bayer MaterialScience) and other non-reactive additives which reduce blistering and blowing or foaming during application of the solventless polyurethane coating system in humid weather or on damp substrates by combining with or adsorbing moisture and/or carbon dioxide. Suitable moisture scavenging additives include but are not limited to calcium sulfate, calcium oxide and synthetic zeolite “molecular sieves”. The amount of moisture scavenging additive used is increased according to the expected humidity at the point where the coating is to be applied. The moisture absorbing materials useful herein are known and are described in U.S. Pat. Nos. 3,755,222, 4,695,618 and 5,275,888, the disclosures of which are herein incorporated by reference. The fillers useful herein include silica, silica flour, barytes, talc, aluminum trihydrate, calcium carbonate, glass spheres, glass fibers and weaves, ceramic spheres and fibers, boron, carbon fibers, graphite, wollastonite, kieselguhr, organic fibers (such as polyamide fibers) and the like.

Composites may be produced using the above-described spray polyurethane-urea compositions in accordance with processes such as those described in, for example, U.S. Pat. Nos. 6,294,248, 6,432,543 and 6,649,107, the disclosures of which are herein incorporated by reference. Suitable information in terms of relevant processes and the corresponding steps for each process, suitable conditions, suitable molds, demold times, end uses, etc. are set forth in these disclosures. Obviously, the spray elastomer compositions described hereinabove are substituted for the specific elastomer compositions used in these disclosures.

Various processes for the production of soft molded composites, and the corresponding molded composites are known and described in, for example, U.S. Pat. Nos. 6,294,248 and 6,432,543, the disclosures of which are herein incorporated by reference. The unique aspect of these processes and the corresponding composites, lies in the improved spray elastomer compositions described hereinabove.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

The definitions of hydroxyl number, amine number and NCO group content are used according to DIN norms:

hydroxyl number: DIN 53240 (Hydroxyl-Zahl)
amine number: DIN 53 176 (Amin Zahl)
NCO group content: DIN 53185 (Isocyanat-Gehalt)

### EXAMPLES

The following components were used to prepare polyol blends in Examples 1-4:

Polyol A: a polyether polyol initiated with glycerine and propylene oxide (86% by wt.) and tipped with ethylene oxide (14% by wt.), having an OH number of 28 and a functionality of 3
Polyol B: a polyether polyol initiated with propylene glycol and propylene oxide (70% by wt.) and tipped with ethylene oxide (30% by wt.), having an OH number of 28 and a functionality of 2
Polyol C: a polymer polyol initiated with glycerine and propylene oxide (81% by wt.) and tipped with ethylene oxide (19% by wt.), containing 20% by wt. of grafted SAN composed of 40% by wt. styrene and 60% by wt. acrylonitrile, having an OH number of 28 and a functionality of 3
Polyol D: a polyether polyol initiated with propylene glycol and propylene oxide (100% by wt.) and having an OH number of 56 and a functionality of 2
DETDA: diethyltoluenediamine, a blend of 80% by weight of the 2,4-isomer and 20% by weight of the 2,6-isomer
IPDA: isophorone diamine
Catalyst A: Triethylendiamine 33% by wt. in solution of dipropylenglycol
Isocyanate A: an isocyanate prepolymer having an NCO group content of 10% which is the reaction product of (i) 38 pbw of diphenylmethane diisocyanate (40% by weight of the 2,2′- and 2,4′-isomers and 60% by weight of the 4,4′-isomer) with (ii) 62 pbw of Polyol D

### Examples 1-4

The polyol blends described in Table 1 were reacted with Isocyanate A in these examples in the amounts indicated in parts by weight (pbw) in Table 1. The properties of the elastomers produced by the specified process are reported in Table 2.

TABLE 1

| Component | Example 1 | Example 2 | Example 3 | Example 4 |
|---|---|---|---|---|
| Polyol A, pbw | 83.2 | 83.2 | — | 78.7 |
| Polyol B, pbw | 11 | 11 | 11 | 11 |
| Polyol C, pbw | — | — | 83.2 | — |
| DETDA, pbw | 5 | — | — | 7 |
| IPDA, pbw | — | 5 | 5 | 2.5 |
| Catalyst A, pbw | 0.80 | 0.8 | 0.8 | 0.8 |
| Isocyanate | A | A | A | A |
| Mixing ratio | 100:48 | 100:50 | 100:50 | 100:70 |
| (@index 105) | | | | |

TABLE 2

| | Formulation | | | | | |
|---|---|---|---|---|---|---|
| | Example 1 | Example 1 | Example 2 | Example 3 | Example 4 | DIN Norm |
| Application method | cast | spray | Cast | cast | Cast | — |
| Hardness/Shore A | 42 | 27 | 44 | 60 | 65 | DIN 53505-2000-08 |
| Density [g/cm³] | 1.055 | 0.719 | 1.055 | 1.066 | 1.065 | DIN EN ISO 854-95 |
| Tensile strength [N/mm²] | 7.09 | 2.67 | 6.15 | 7.49 | 12.29 | DIN 53504-1994-05 |
| Elongation at break [%] | 873 | 654 | 747 | 337 | 798 | DIN 53504-1994-05 |
| Tear strength [N/mm] | 8.9 | 6.0 | 9.3 | 8.8 | 13.6 | DIN ISO 34-1-2004-07 |

Elastomers were prepared by combining the mixture of polyol blends and by mixing in a high pressure spray gun or in a low pressure casting machine with the appropriate quantity of Isocyanate A so as to maintain an NCO/OH ratio of 1.05. The resultant elastomers were then tested for their properties according to Table 2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A sprayable elastomer comprising the reaction product of:
(A) a polyisocyanate and/or NCO-prepolymer and/or modified polyisocyanate thereof with an isocyanate content from about 6 to 20%;
with
(B) an isocyanate-reactive component comprising:
(1) from about 70 to about 99% by weight, based on 100% of the combined weight of components (1) and (2), of one or more compounds containing from about 1.5 to about 6 isocyanate-reactive groups except primary or secondary amine groups having molecular weight of from about 60 to about 8,000, and an OH number of from about 14 to about 1870,
and
(2) from about 1 to about 30% by weight, based on 100% of the combined weight of components (1) and (2), of one or more compounds containing from about 1.5 to about 4 primary or secondary amine groups, having a molecular weight of from about 60 to about 500, and an NH number of from about 225 to about 1870;
and optionally
(C) one or more catalysts,
(D) one or more anti-oxidants,
(E) one or more UV stabilizers,
and
(F) one or more colorants,
wherein a ratio of the total number of isocyanate groups present to the total number of isocyanate-reactive groups present of from about 0.80:1 to about 1.20:1 is employed.

2. The elastomer of claim 1 in which (A) comprises a prepolymer of diphenylmethane diisocyanate having an NCO group content of 9 to 13% and which comprises the reaction product of (i) diphenylmethane diisocyanate comprising from about 2 to 60% by weight, based on total weight of MDI, of 2,4′-MDI, from about 0 to 5% by weight, based on total weight of MDI, of 2,2′-MDI, and from about 40 to 98% by weight, based on total weight of MDI, of 4,4′-MDI, with (ii) an isocyanate-reactive component which contains from about 1.5 to 3 isocyanate-reactive groups, and has a molecular weight of from about 200 to about 8,000.

3. The elastomer of claim 1 in which the isocyanate-reactive component (B) comprises:
(1) from about 80 to 99% by weight, based on 100% of total combined weight of components (1) and (2), of a polyether polyol containing from about 2 to 4 hydroxyl groups, having a molecular weight of about 60 to 7,000 and an OH number of from about 20 to about 1870,
and
(2) from about 1 to 20% by weight, based on 100% of total combined weight of components (1) and (2), of one or more compounds containing from about 1.8 to 3 primary and/or secondary amine groups, having a molecular weight of about 100 to 400, and an NH number of from about 280 to 1120.

4. The elastomer of claim 1 in which the ratio of the total number of isocyanate groups present to the total number of isocyanate-reactive groups present is from about 0.90:1 to about 1.10:1.

5. A process for the production of a composite in a closed mold comprising:
(I) applying a composition which forms a soft elastomer to interior walls of an open mold, wherein the composition comprises:
(A) a polyisocyanate, an NCO-terminated prepolymer or a modified polyisocyanate having an isocyanate content from about 6 to 20%; with
(B) an isocyanate-reactive component comprising:
(1) from about 70 to about 99% by weight, based on 100% of total combined weight of components (1) and (2), of one or more compounds having from about 1.5 to about 6 isocyanate-reactive groups except primary or secondary groups, having a molecular weight of from about 60 to about 8,000, and an OH number of from about 14 to about 1870,
and
(2) from about 1 to about 30% by weight, based on 100% of total combined weight of components (1) and (2), of one or more compounds having from about 1.5 to about 4 primary or secondary amine groups, having a molecular weight of from about 60 to about 500, and an NH number of from about 225 to about 1870;
and, optionally,
(C) one or more catalysts,
(D) one or more anti-oxidants,
(E) one or more UV stabilizers,
and
(F) one or more colorants,
wherein a ratio of total number of isocyanate groups present to total number of isocyanate-reactive groups present of from about 0.80 to about 1.20 is employed;
(II) introducing a polyurethane and/or polyurea filling composition into the mold which has walls coated with the composition that forms a soft elastomer in an amount such that the mold will be filled and a manner such that the filling composition will be substantially completely within the soft elastomer-forming composition on the mold walls;
(III) closing the mold;
and
(IV) allowing the composition introduced in (II) to cure.

6. The process of claim 5 in which the elastomer-forming composition is sprayed onto the mold walls to a thickness of at least 0.3 mm.

7. The process of claim 5 in which the elastomer-forming composition forms an elastomer within from about 15 to about 120 seconds from time of application to the mold wall.

8. The process of claim 5 in which the composition applied to the mold wall in (I) is applied by spraying.

9. The process of claim 5 in which the filling composition introduced in (II) is introduced by injection, casting or spraying it into the mold.

10. The process of claim 5 in which the mold is a mold for a seat cushion or a cushion pad.

11. The process of claim 5 in which the mold is closed prior to introduction of the foam forming mixture in accordance with step (II).

12. The process of claim 5 in which the mold is closed after step (II) has begun but prior to completion of step (IV).

13. A composite molded article produced by the process of claim 5.

14. A method of making a decorative component in a mold having a mold cavity comprising:
(I) applying a urethane based coating having a predetermined color to the mold cavity;
(II) applying an elastomer-forming composition over the coating in the mold cavity and allowing the elastomer to at least partially cure to form an elastomeric layer, wherein the elastomer comprises the reaction product of:
(A) a polyisocyanate and/or prepolymer and/or modified polyisocyanate having an isocyanate content from about 6 to 20%;
with
(B) an isocyanate-reactive component comprising:
(1) from about 70 to about 99% by weight, based on 100% of total combined weight of components (1) and (2), of one or more compounds containing from about 1.5 to about 6 isocyanate-reactive groups except primary or secondary groups having molecular weight of from about 60 to about 8,000, and an OH number of from about 14 to about 1870,
and
(2) from about 1 to about 30% by weight, based on 100% of total combined weight of components (1) and (2), of one or more compounds containing from about 1.5 to about 4 primary or secondary amine groups, having a molecular weight of from about 60 to about 500, and an NH number of from about 225 to about 1870;
and optionally
(C) one or more catalysts,
(D) one or more anti-oxidants,
(E) one or more UV stabilizers,
and
(F) one or more colorants,
wherein the ratio of the total number of isocyanate groups present to the total number of isocyanate-reactive groups present is from about 0.80:1 to about 1.20:1.
and
(III) demolding the decorative component.

15. The method of claim 14, further comprising introducing a polyurethane and/or polyurea filling composition into the mold cavity and applying the filling composition to the elastomeric layer to form a backing layer on the decorative component.

16. The method of claim 14, further comprising applying a polyurethane filling composition to the elastomeric layer after demolding the decorative component.

17. The method of claim 14, wherein the elastomer-forming composition applied in (II) is applied by spraying.

18. The decorative component produced by the method of claim 14.

19. A method of making a decorative component in a mold having a mold cavity comprising:
(I) applying an elastomer-forming composition within the mold cavity and allowing the elastomer-forming composition to at least partially cure, thereby forming an elastomeric layer, wherein the elastomer-forming composition comprises the reaction product of:
(A) a polyisocyanate and/or prepolymer and/or modified polyisocyanate thereof with an isocyanate content from about 6 to 20%;
with
(B) an isocyanate-reactive component comprising:
(1) from about 70 to about 99% by weight, based on 100% of total combined weight of components (1) and (2), of one or more compounds containing from about 1.5 to about 6 isocyanate-reactive groups except primary or secondary groups having molecular weight of from about 60 to about 8,000, and an OH number of from about 14 to about 1870,
and
(2) from about 1 to about 30% by weight, based on 100% of total combined weight of components (1) and (2), of one or more compounds containing from about 1.5 to about 4 primary or secondary amine groups, having a molecular weight of from about 60 to about 500, and an NH number of from about 225 to about 1870;
and optionally
(C) one or more catalysts,
(D) one or more anti-oxidants,
(E) one or more UV stabilizers,
and
(F) one or more colorants,
wherein a ratio of total number of isocyanate groups present to total number of isocyanate-reactive groups present of from about 0.80:1 to about 1.20:1 is used;
(II) optionally, introducing a polyurethane and/or polyurea filling material composition into the mold cavity and applying the filling material composition to the at least partially cured elastomeric layer to form a backing layer on the decorative component;
and
(III) demolding the decorative component.

20. The method of claim 19, further comprising applying a urethane based coating to the mold cavity prior to (I).

21. The method of claim 19, further comprising applying a urethane based coating to the elastomeric layer after demolding the resultant decorative component.

22. The decorative component produced by the method of claim 19.
